(19) United States
(12) Patent Application Publication
(10) Pub. No.: US 2016/0185082 A1
(43) Pub. Date: Jun. 30, 2016

(54) Reflections Décor II

(71) Applicant: Poyan Taherloo, Copenhagen (DK)

(72) Inventor: Poyan Taherloo, Copenhagen (DK)

(21) Appl. No.: 14/600,118

(22) Filed: Jan. 20, 2015

(30) Foreign Application Priority Data
Feb. 25, 2014 (DK) PA 2014 00105

(51) Int. Cl. B32B 7/12; B32B 37/12

(52) U.S. Cl. CPC B32B 7/12; B32B 37/12; B32B 2307/412; B32B 2590/00

(57) ABSTRACT

This invention relates to a multipurpose decorative board, consisting of filling and retention of filling materials between two transparent layers, which may consist of sheets of glass or plastic.

Decoration consisting in filling and retention, and thus the preservation of various filling materials between two transparent layers.

Filling materials are more or less transparent and allow for various quantities and colors of light to penetrate or reflect. The composition of different filling materials form a specific pattern in shape and color.

Decoration is characterized by the filling materials used in the decorations appearance being segregated, using a sheet with holes for specific filling materials according to the specific pattern, which is located between the two outer transparent layers. Holes in the intermediate sheet thus form space for specific fill materials according to specific pattern.

Decoration is characterized by the filling materials consisting of cuts from intermediate sheet, that are applied adhesive foil or film of different properties according to specific pattern. The adhesive foil is cut in same shape as cuts in the intermediate sheet, and it is applied these cuts before they are put back in the sheet as filling materials. Adhesive foil can also be applied both sides of the intermediate sheet independent of cuts in the sheet, according to pattern.

Decoration is characterized by that the sheet and particularly filling materials in sheets' cuts light up by light from LED light strip, that is installed in outline of decoration, under u-profile. Thus it is the intermediate sheet of clear plastic, that lead the light through the sheet and illuminate it, while particularly cuts and thereby filling materials light up.

Thus the decoration basically consists of two transparent layers attached around intermediate sheet with holes and filling materials according to specific pattern.

The variables that can be different from layer to layer in the same decoration or from decoration to decoration are the following:

size of the pattern and the surrounding transparent layers, and thus the ratio between these

shape of the surrounding transparent layers

distance between the two surrounding transparent layers and thus the thickness of the intermediate sheet. Furthermore the thickness of intermediate sheet determine depth in the pattern and the amount of light that is lead to the cuts and thus illuminate the filling materials

the intermediate sheets' size and position in relation to the transparent layers

number of intermediate sheets under same two surrounding transparent layers

number of intermediate sheets that are each separated by outer transparent layers, so that the initial two transparent layers and intermediate sheet are added yet another intermediate sheet and a transparent layer

method for attaching together the parts of the decoration including by use of bolts going through, glass adapters, glass clamps, glue, brackets or framework

holes in the intermediate sheet consisting of clear transparent plastic, cut by laser cutting, according to specific pattern

filling materials in specific holes in the intermediate sheet according to specific pattern, including cuts from intermediate sheet that are applied adhesive foil

adhesive foil that is applied intermediate sheet according to specific pattern, independent of cuts in this sheet

the use of glass or plastic of different properties as surrounding transparent layers

### FIELD OF INVENTION

This invention relates to a multipurpose decorative board, consisting of filling and retention of filling materials between two transparent layers, which may consist of sheets of glass or plastic.

### THE PRIOR ART

The relevant prior art is described in the following documents: (D1) US 4944969 (USUI) 1990.07.31; (D2) US 6416204 B1 (CUTSHAW) 2002.07.09; (D3) US 2005/0276957 A1 (RUNKEL) 2005.12.15 and (D4) DK PA 2010 00481 (TAHERLOO).

D1 describes a decoration where different filling materials are placed between a number of transparent sheets, that can consist of glass or plastic. A frame holds the parts together, so that they form a single unit.

A similar technique is known from D2 and D3, and D1-D3 describes different materials that are suitable as filling in the decoration. Materials or objects in the decoration all have the purpose of forming a decorative pattern.

D4 describes a similar decoration, that is different by holes in one or more sheets between the outer transparent layers containing filling materials. D4 describes different materials that can be used as intermediate sheet, and different methods to cut the holes in this sheet.

D4 also describes different installations in the decoration such as electric light.

The following invention differs from the prior art as filling materials also include cuts from the intermediate sheet consisting of transparent clear acrylic plastic, that are applied adhesive foil or film of different properties, according to specific pattern. This adhesive foil is cut in the same shape as the cuts from the intermediate sheet, and it is applied these cuts before they are put back in the sheet as filling materials. Adhesive foil can furthermore be applied both sides of the intermediate sheet independent of cuts in this sheet, according to specific pattern. The decoration and particularly filling materials in the holes created by cuts in the intermediate sheet, are illuminated by LED light strips , that are installed in the outline of the decoration, under u-profile. Thus it is the intermediate sheet consisting of transparent clear acrylic plastic, that lead the light through the sheet and illuminate it, while particularly cuts and thereby filling materials are illuminated.

Light from outline of the decoration is lead through the different cuts and thus filling materials in the patter. As the intermediate sheet consist of clear transparent acrylic plastic like the cuts and filling materials, the cuts that are applied adhesive foil according to pattern, will not affect the colors of each other, which would be the case if filling materials was cuts from another sheet.

Colors on the light in the pattern of decoration will thus light up according to properties of the adhesive foil that is applied to the cuts of intermediate sheet, and used as filling materials according to pattern. Thus the different colors in the pattern will not affect each other as a result of the light being lead through the total decoration.

The application of this method for production of decoration is practically and economically associated with particularly 2 crucial benefits. Partly it means the application of less material, as cuts from the intermediate sheet is used as filling materials, in stead of cuts from other sheets, and partly because of the same reason, a less amount of laser cutting is necessary in the production.

In addition the acquisition of acrylic plastic in different colors according to specific pattern, for cutting and use as filling materials in intermediate sheet, is very much more difficult than the acquiring and cutting of adhesive foil, according to the pattern in the decoration. Adhesive foil of different properties according to specific pattern is machine cut by using same drawing that is used for laser cutting of the intermediate sheet, and is very easy to apply the cuts.

Furthermore transparent adhesive foil is used to seal the decoration, so that moisture, dust or other particles do not penetrate the different layers of the decoration. This adhesive foil can be applied as a strip on the outline of the decoration, so that a ribbon with the same width as the total depth of the decoration is applied to the outline. In addition the foil can be applied as a frame, so that the foil partly comes down both sides of the decoration, like an u-profile.

This method for sealing of the decoration as part of manufacturing is associated with particularly 2 crucial benefits. From a technical perspective existing standards regarding u-profiles only allow one layer of the adhesive foil to come down the sides of the decoration as a frame, because further layers would expand the depth of the decoration, so that standard u-profile can not be used. Therefore only one layer comes down the sides of the decoration as a frame, as last layer after one or more layers of foil applied as a strip to the outline of the decoration, which will expand the size of the decoration and not the depth, why standard u-profile can be used.

Regarding the appearance of the decoration this technique also makes it possible to manufacture decoration without the use of u-profiles. It allows that adhesive foil in multiple layers and of different properties according to pattern, to be used as a simple and very beautiful alternative to u-profile, where LED light strips and the decoration is sealed and protected. Thus the pattern in the appearance of decoration can also go all the way to the edge without being affected by any u-profile.

This technique and associated method for manufacturing, makes it much more accessible to produce illuminated decorations with different depths and reflections, which are also much more accurate according to a specific pattern.

### DETAILED DESCRIPTION

Decoration consisting in filling and retention, and thus the preservation of various filling materials between two transparent layers.

Filling materials are more or less transparent and allow for various quantities and colors of light to penetrate or reflect. The composition of different filling materials form a specific pattern in shape and color.

Decoration is characterized by the filling materials used in the decorations appearance being segregated, using a sheet with holes for specific filling materials according to the specific pattern, which is located between the two outer transparent layers. Holes in the intermediate sheet thus form space for specific fill materials according to specific pattern.

Decoration is characterized by the filling materials consisting of cuts from intermediate sheet, that are applied adhesive foil or film of different properties according to specific pattern. The adhesive foil is cut in same shape as cuts in the intermediate sheet, and it is applied these cuts before they are put back in the sheet as filling materials. Adhesive foil can also be applied both sides of the intermediate sheet independent of cuts in the sheet, according to pattern.

Decoration is characterized by that the sheet and particularly filling materials in sheets' cuts light up by light from LED light strip, that is installed in outline of decoration, under u-profile. Thus it is the intermediate sheet of clear plastic, that lead the light through the sheet and illuminate it, while particularly cuts and thereby filling materials light up.

Thus the decoration basically consists of two transparent layers attached around intermediate sheet with holes and filling materials according to specific pattern.

The variables that can be different from layer to layer in the same decoration or from decoration to decoration are the following:

size of the pattern and the surrounding transparent layers, and thus the ratio between these

shape of the surrounding transparent layers

distance between the two surrounding transparent layers and thus the thickness of the intermediate sheet. Furthermore the thickness of intermediate sheet determine depth in the pattern and the amount of light that is lead to the cuts and thus illuminate the filling materials

the intermediate sheets' size and position in relation to the transparent layers

number of intermediate sheets under same two surrounding transparent layers

number of intermediate sheets that are each separated by outer transparent layers, so that the initial two transparent layers and intermediate sheet are added yet another intermediate sheet and a transparent layer

method for attaching together the parts of the decoration including by use of bolts going through, glass adapters, glass clamps, glue, brackets or framework

holes in the intermediate sheet consisting of clear transparent plastic, cut by laser cutting, according to specific pattern

filling materials in specific holes in the intermediate sheet according to specific pattern, including cuts from intermediate sheet that are applied adhesive foil

adhesive foil that is applied intermediate sheet according to specific pattern, independent of cuts in this sheet

the use of glass or plastic of different properties as surrounding transparent layers

### Filling Materials

Filling materials used in the decoration include:

cuts from intermediate sheet that are applied adhesive foil of different properties according to specific pattern

cuts from the other sheets

small pieces of glass, including frit, of various properties

shavings of various types of metals

different types of stones, wood, sand, ceramics and gravel of different properties

various natural materials such leaves, fruits, flowers, beans, berries, plants, water and ice, air, sea shells

different types of beads

### Manufacturing

Method for manufacturing of decoration is characterized by filling materials being segregated according to specific pattern by holes in a intermediate sheet that is attached between two transparent layers. Sheet with holes, forming space for specific filling materials is placed on top of one transparent layer, thus creating the space for filling materials, which can then be filled in before the second transparent layer is fitted, thus encapsulating the filling materials and making decoration stand as a single unit.

This procedure is as following:

a. sheet with holes according to specific pattern, is placed on top of the first transparent layer

b. specific filling materials selected according to specific pattern is filled in specific holes

c. adhesive foil applied intermediate sheet, independent of cuts, independent of cuts, according to specific pattern

d. the second transparent layer is mounted on top and thus encapsulating fill materials

e. this process is repeated if there are more than two transparent layers in the decoration

f. finally the parts are fastened to each other, and the decoration is now a single unit

Method for manufacturing of decoration is characterized by transparent clear foil used to seal decoration, so that moisture, dust or other particles do not penetrate the different layers, and damage the decoration. This adhesive foil can be applied as a strip on the outline of the decoration, so that a ribbon of the same width as the decorations' total depth is applied the outline. The foil can furthermore be applied as a frame, so that some part of the foil also comes down both sides of the decoration, like a u-profile.

### Applications

The decoration is a multipurpose panel. The applications of the decoration include:

art and decoration for wall, floor or front of a window, or sculptures positioned relative to light in a room

part of signage and advertising with the company name, logo etc.,

workable decoration as tabletops, room dividers for room and office, floor decoration after gold carpeting lighting appliances, shelves for shelving and other display cases, blinds, heaters and refrigeration equipment

decoration for the manufacturing of doors and windows of various properties

building decoration, decorative facades, balconies, railings, walls and roofs, floor structures, visors, or installed as a mosaic on gables or walls, both indoors and outdoors

### SUMMARY

This invention relates to a multipurpose decorative board, consisting of filling and retention of filling materials between two transparent layers, which may consist of sheets of glass or plastic.

Decoration consisting in filling and retention, and thus the preservation of various filling materials between two transparent layers.

Filling materials are more or less transparent and allow for various quantities and colors of light to penetrate or reflect. The composition of different filling materials form a specific pattern in shape and color.

Decoration is characterized by the filling materials used in the decorations appearance being segregated, using a sheet with holes for specific filling materials according to the specific pattern, which is located between the two outer transparent layers. Holes in the intermediate sheet thus form space for specific fill materials according to specific pattern.

Decoration is characterized by the filling materials consisting of cuts from intermediate sheet, that are applied adhesive foil or film of different properties according to specific pattern. The adhesive foil is cut in same shape as cuts in the intermediate sheet, and it is applied these cuts before they are put back in the sheet as filling materials. Adhesive foil can also be applied both sides of the intermediate sheet independent of cuts in the sheet, according to pattern.

Decoration is characterized by that the sheet and particularly filling materials in sheets' cuts light up by light from LED light strip, that is installed in outline of decoration, under u-profile. Thus it is the intermediate sheet of clear plastic, that lead the light through the sheet and illuminate it, while particularly cuts and thereby filling materials light up.

Thus the decoration basically consists of two transparent layers attached around intermediate sheet with holes and filling materials according to specific pattern.

The variables that can be different from layer to layer in the same decoration or from decoration to decoration are the following:

size of the pattern and the surrounding transparent layers, and thus the ratio between these

shape of the surrounding transparent layers

distance between the two surrounding transparent layers and thus the thickness of the intermediate sheet. Furthermore the thickness of intermediate sheet determine depth in the pattern and the amount of light that is lead to the cuts and thus illuminate the filling materials

the intermediate sheets' size and position in relation to the transparent layers

number of intermediate sheets under same two surrounding transparent layers

number of intermediate sheets that are each separated by outer transparent layers, so that the initial two transparent layers and intermediate sheet are added yet another intermediate sheet and a transparent layer

method for attaching together the parts of the decoration including by use of bolts going through, glass adapters, glass clamps, glue, brackets or framework

holes in the intermediate sheet consisting of clear transparent plastic, cut by laser cutting, according to specific pattern

filling materials in specific holes in the intermediate sheet according to specific pattern, including cuts from intermediate sheet that are applied adhesive foil

adhesive foil that is applied intermediate sheet according to specific pattern, independent of cuts in this sheet

the use of glass or plastic of different properties as surrounding transparent layers

What is claimed is:

1. Decoration consisting in filling and retention, and thus the preservation of various filling materials between two transparent layers.
Filling materials are more or less transparent and allow for various quantities and colors of light to penetrate or reflect. The composition of different filling materials form a specific pattern in shape and color.
Decoration is characterized by the filling materials used in the decorations appearance being segregated, using a sheet with holes for specific filling materials according to the specific pattern, which is located between the two outer transparent layers. Holes in the intermediate sheet thus form space for specific fill materials according to specific pattern.
Decoration is characterized by the filling materials consisting of cuts from intermediate sheet, that are applied adhesive foil or film of different properties according to specific pattern. The adhesive foil is cut in same shape as cuts in the intermediate sheet, and it is applied these cuts before they are put back in the sheet as filling materials. Adhesive foil can also be applied both sides of the intermediate sheet independent of cuts in the sheet, according to pattern.
Decoration is characterized by that the sheet and particularly filling materials in sheets' cuts light up by light from LED light strip, that is installed in outline of decoration, under u-profile. Thus it is the intermediate sheet of clear plastic, that lead the light through the sheet and illuminate it, while particularly cuts and thereby filling materials light up.
Thus the decoration basically consists of two transparent layers attached around intermediate sheet with holes and filling materials according to specific pattern.
The variables that can be different from layer to layer in the same decoration or from decoration to decoration are the following:
size of the pattern and the surrounding transparent layers, and thus the ratio between these
shape of the surrounding transparent layers
distance between the two surrounding transparent layers and thus the thickness of the intermediate sheet. Furthermore the thickness of intermediate sheet determine depth in the pattern and the amount of light that is lead to the cuts and thus illuminate the filling materials
the intermediate sheets' size and position in relation to the transparent layers
number of intermediate sheets under same two surrounding transparent layers
number of intermediate sheets that are each separated by outer transparent layers, so that the initial two transparent layers and intermediate sheet are added yet another intermediate sheet and a transparent layer
method for attaching together the parts of the decoration including by use of bolts going through, glass adapters, glass clamps, glue, brackets or framework
holes in the intermediate sheet consisting of clear transparent plastic, cut by laser cutting, according to specific pattern
filling materials in specific holes in the intermediate sheet according to specific pattern, including cuts from intermediate sheet that are applied adhesive foil
adhesive foil that is applied intermediate sheet according to specific pattern, independent of cuts in this sheet

2. Decoration according to claim 1 characterized by that surrounding transparent layers may consist of glass of different properties.

3. Decoration according to claim 1 characterized by that surrounding transparent layers may consist off plastic of different properties.

4. Decoration according to claim 1 characterized by that filling materials used in the decoration include:
cuts from intermediate sheet that are applied adhesive foil of different properties according to specific pattern
cuts from the other sheets
small pieces of glass, including frit, of various properties
shavings of various types of metals
different types of stones, wood, sand, ceramics and gravel of different properties
various natural materials such leaves, fruits, flowers, beans, berries, plants, water and ice, air, sea shells
different types of beads

5. Method for manufacturing of decoration according to claim 1 is characterized by filling materials being segregated according to specific pattern by holes in a intermediate sheet that is attached between two transparent layers. Sheet with holes, forming space for specific filling materials is placed on top of one transparent layer, thus creating the space for filling materials, which can then be filled in before the second transparent layer is fitted, thus encapsulating the filling materials and making decoration stand as a single unit.
This procedure is as following:
a. sheet with holes according to specific pattern, is placed on top of the first transparent layer
b. specific filling materials selected according to specific pattern is filled in specific holes
c. adhesive foil applied intermediate sheet, independent of cuts, independent of cuts, according to specific pattern
d. the second transparent layer is mounted on top and thus encapsulating fill materials
e. this process is repeated if there are more than two transparent layers in the decoration
f. finally the parts are fastened to each other, and the decoration is now a single unit
Method for manufacturing of decoration is characterized by transparent clear foil used to seal decoration, so that moisture, dust or other particles do not penetrate the different layers, and damage the decoration. This adhesive foil can be applied as a strip on the outline of the decoration, so that a ribbon of the same width as the decorations' total depth is applied the outline. The foil can furthermore be applied as a frame, so that some part of the foil also comes down both sides of the decoration, like a u-profile.

6. Application according to claim 1. is the decoration as a multipurpose panel. The applications of the decoration include:
art and decoration for wall, floor or front of a window, or sculptures positioned relative to light in a room
part of signage and advertising with the company name, logo etc.,
workable decoration as tabletops, room dividers for room and office, floor decoration after gold carpeting lighting appliances, shelves for shelving and other display cases, blinds, heaters and refrigeration equipment
decoration for the manufacturing of doors and windows of various properties
building decoration, decorative facades, balconies, railings, walls and roofs, floor structures, visors, or installed as a mosaic on gables or walls, both indoors and outdoors
